(19) United States
(12) Patent Application Publication
(10) Pub. No.: US 2018/0126356 A1
(43) Pub. Date: May 10, 2018

(54) CHILL-PROOFING COMPOSITE FILTER AIR AND RELATED METHODS

(71) Applicant: Imerys Filtration Minerals, Inc., San Jose, CA (US)

(72) Inventors: Robert FLEMING, San Jose, CA (US); Scot BIRMINGHAM, San Francisco, CA (US); Nathan DIAS, San Jose, CA (US)

(21) Appl. No.: 15/577,775

(22) PCT Filed: Jul. 28, 2016
(86) PCT No.: PCT/US2016/044429

§ 371 Date: Nov. 29, 2017

Related U.S. Application Data
(60) Provisional application No. 62/198,474, filed on Jul. 29, 2015.

(51) Int. Cl. B01J 20/14; B01J 20/10; B01J 20/28; B01J 20/32; C12H 1/044; B01D 37/02

(52) U.S. Cl. CPC B01J 20/14; B01J 20/103; B01J 20/28071; B01J 20/28083; B01D 37/02; B01J 20/28061; B01J 20/28047; B01J 20/3204; C12H 1/0408; B01J 20/28059

(57) ABSTRACT

A chill-proofing composite filter aid may include a filtration component and an adsorption component including precipitated silica at least partially coating the filtration component. The composite filter aid may have a pore volume of at least about 0.15 cm³/gram at an average pore size between 3 nanometers and 15 nanometers. A method for removing particles from a fluid may include providing a chill-proofing composite filter aid, pre-coating a filter element with the composite filter aid, and passing a fluid containing particles to be adsorbed through the coated filter element. A method of making a chill-proofing composite filter aid may include providing a filtration component, and at least partially coating the filtration component with an adsorption component including precipitated silica. The composite filter aid may have a pore volume of at least about 0.15 cm³/gram at an average pore size between 3 nanometers and 15 nanometers.

### CLAIM FOR PRIORITY

This application claims benefit of priority to U.S. Provisional Patent Application No. 62/198,474, filed Jul. 29, 2015, the entire contents of which are incorporated herein by reference.

### BACKGROUND

### Field of Disclosure

The present disclosure relates to chill-proofing composite filter aids and related methods, and more particularly, to chill-proofing composite filter aids including a filtration component and an adsorption component including precipitated silica, and related methods.

### Background

In many filtration applications, a filtration device includes both a filter element, such as a septum, and a filter aid material. The filter element may be of any form that supports a filter aid material, for example, a cylindrical tube or wafer-like structure covered with a plastic or metal fabric of sufficiently fine weave. The filter element may be a porous structure having a filter element void to allow material of a certain size to pass through the filtration device. The filter aid material may include one or more filtration components, which may include inorganic powders or organic fibrous materials. Such filter aid materials may be used in combination with a filter element to enhance filtration performance. Filtration components for use in a filter aid material may include materials, such as, for example, diatomaceous earth, perlite, and cellulose. As an example, the filter aid material may initially be applied to the filter septum in a process known as “pre-coating.” Pre-coating generally involves mixing a slurry of water and filter aid material and introducing the slurry into a stream flowing through the septum. During this process, a thin layer, for example, 1.5 millimeters to about 3 millimeters of filter aid material, may be deposited on the filter septum, thus forming the filtration device.

During the filtration of a fluid, various particles in the fluid may be trapped by the filter aid material. The combined layers of filter aid material and the particles and/or constituents to be removed accumulate on the surface of the filter septum. Those combined layers are known as “filter cake,” As more particles and/or constituents are deposited and accumulate on the filter cake, the filter cake may become saturated with debris to the point where fluid is no longer able to pass through the filter septum.

To counteract saturation, a process known as “body feeding” may be used. Body feeding is the process of introducing additional filter aid material into the fluid to be filtered before the fluid reaches the filter cake. The filter aid material will follow the path of the unfiltered fluid and will eventually reach the filter cake. Upon reaching the filter cake, the added filter aid material tends to bind to the filter cake in much the same way the filter aid material adhered to the filter septum during the pre-coating process. The additional layer of filter aid material may cause the filter cake to swell and thicken, and may increase the capacity of the filter cake to trap additional debris. The filter aid material typically has an open porous structure, which maintains an open structure in the filter cake, thus rehabilitating permeability of the filter cake.

In the field of fluid filtration, many methods of particle separation employ materials chosen from, for example, diatomaceous earth, expanded perlite, natural glasses, and cellulose materials, as porous filtration components. Those materials have intricate and porous structures that may be particularly suited to the effective physical entrapment of particles in filtration processes. Those intricate and porous structures create networks of void spaces that may result in buoyant filtration media particles that have apparent densities similar to those of the fluids in which they are suspended. Porous filtration components may be employed when improving the clarity of fluids. The porous filtration components may be used to remove undesired particles from a fluid. However, while well-suited for the task of removing particulate matter by physical entrapment, such porous filtration components may not be as well-suited for removing particulate matter from a fluid by the process of adsorption.

As used herein, “adsorption” refers to the tendency of molecules from an ambient fluid phase to adhere to the surface of a solid. This should not to be confused with the term “absorption,” which results when molecules from an ambient fluid diffuse into a solid, as opposed to adhering to the surface of the solid. To achieve a desired adsorptive capacity, an adsorbent component may have a relatively large surface area, which may imply a fine porous structure.

One method of using an adsorbent component is to place the adsorbent component in contact with a fluid containing particles and/or constituents to be adsorbed, either to purify the fluid by removing the particles and/or constituents, or to isolate the particles and/or constituents so as to purify them.

Diatomaceous earth is a sediment enriched in biogenic silica in the form of the siliceous frustules of diatoms, a diverse array of microscopic, single-cell algae. Those frustules are sufficiently durable to retain much of their microscopic structure through long periods of geological time and through thermal processing. Diatomaceous earth products have an inherently intricate and porous structure composed primarily of silica. This characteristic renders them useful in filter aids.

As used herein, “turbidity” refers to the cloudiness or haziness of a fluid, where the haze may be caused by individual particles that are suspended in the fluid. Materials that may cause a fluid to be turbid include, for example, clay, silt, organic matter, inorganic matter, and microscopic organisms. Turbidity may be measured by using an instrument known as a nephelometric turbidimeter that emits a beam of light through a column of the fluid being tested. A detector is placed perpendicular to the beam of light and 90° scatter is measured. A fluid that contains a relatively large number of suspended particles will reflect a greater amount of light than a fluid containing fewer particles. Turbidity measured in this manner may be quantified in Nephelometric Turbidity Units (“NTU”). Turbidity may also be measured via gravimetric methods.

A trade-off typically exists in filter aid technology between the permeability of the porous media used as a filtration component and its turbidity removal capabilities. Filtration components are produced in grades over a wide range of permeability ratings. As the permeability of the filtration component decreases, the ability of the filter aid material to remove small particles may increase, but often at the expense of a slower flow rate through the filter-aid material. Conversely, as the filtration component permeability increases, the ability of the filter aid material to filter particles may decrease and, consequently, the fluid flow through the filter aid material increases. The extent to which this takes place may depend on the type and/or particle size distribution of the suspended particles being removed from the fluid.

It is currently known that, unless specially treated, some chilled fluids, such as, for example, chilled beer, may undergo a chemical reaction that results in the production of insoluble particles. In such chemical reactions, hydrogen bonds may form between haze-active proteins and/or polyphenols in a chilled condition. The reacted proteins and/or polyphenols may then grow to large particles, which cause the fluid to become turbid, a condition also known as “chili-haze,” Chill-haze may be undesirable to both consumers and brewers. Turbidity may be most pronounced when the fluid has been chilled below room temperature. In certain instances, such as when the particles are proteins, as the temperature increases, the hydrogen bonds that hold the proteins together may be broken, “Chill-proofing” may include a process to remove particles creating chill-haze in fluids such as beer.

Thus, it may be desirable to develop filter aids and related methods for chili-proofing fluids, such as beer, that do not necessarily suffer from possible drawbacks associated with prior filter aids and methods. The filter aids and methods disclosed herein may mitigate or eliminate one or more of such drawbacks.

### SUMMARY

In the following description, certain aspects and embodiments will become evident. It should be understood that the aspects and embodiments, in their broadest sense, could be practiced without having one or more features of these aspects and embodiments. It should be understood that these aspects and embodiments are merely exemplary.

According to a first aspect, a chill-proofing composite filter aid may include a filtration component and an adsorption component including precipitated silica at least partially coating the filtration component. The composite filter aid may have a pore volume of at least about 0.15 cm³/gram at an average pore size between 3 nanometers and 15 nanometers, as measured by nitrogen adsorption. According to a further aspect, the filtration component may include diatomaceous earth.

According to yet another aspect, a method for removing particles from a fluid may include providing a chill-proofing composite filter aid. The composite filter aid may include a filtration component and an adsorption component including precipitated silica at least partially coating the filtration component. The composite filter aid may have a pore volume of at least about 0.15 cm³/gram at an average pore size between 3 nanometers and 15 nanometers, as measured by nitrogen adsorption. The method may further include pre-coating a filter element with the composite filter aid, and passing a fluid containing particles to be adsorbed through the coated filter element.

According to a further aspect, a method of making a chill-proofing composite filter aid may include providing a filtration component and at least partially coating the filtration component with an adsorption component including precipitated silica. The composite filter aid may have a pore volume of at least about 0.15 cm³/gram at an average pore size between 3 nanometers and 15 nanometers, as measured by nitrogen adsorption.

Aside from the arrangements set forth above, the embodiments could include a number of other arrangements, such as those explained hereinafter. It is to be understood that both the foregoing description and the following description are exemplary only.

### BRIEF DESCRIPTION OF THE DRAWINGS

The accompanying drawings, which are incorporated in and constitute a part of this description, illustrate several exemplary embodiments and together with the description, serve to explain the principles of the embodiments. In the drawings,

FIG. 1 is a graph showing the incremental pore volume (cm³/gram) vs. average pore size (nanometers (nm)) for four sample composite filter aids.

FIG. 2 is a graph showing the incremental pore volume (cm³/gram) vs. average pore size (nanometers (nm)) for four sample composite filter aids.

FIG. 3 is a graph showing the correlation between filter aid pore volume and chill haze reduction tested for high gravity BUDWEISER® beer.

FIG. 4 is a graph showing pore size vs. post-reaction pH adjustment of precipitated silica samples.

FIG. 5 is a graph showing the pore volume of two filter aid samples as a function of precipitated silica loading on diatomaceous earth.

### DESCRIPTION OF EXEMPLARY EMBODIMENTS

Reference will now be made in more detail to a number of exemplary embodiments of the compositions and methods.

According to some embodiments, a chill-proofing composite filter aid may include a filtration component and an adsorption component including precipitated silica at least partially coating the filtration component. The composite filter aid may have a pore volume of at least about 0.15 cm³/gram at an average pore size between 3 nanometers and 15 nanometers, as measured by nitrogen adsorption. According to a further aspect, the filtration component may include diatomaceous earth. As used herein, the term “composite filter aid” refers to a material including at least one filtration component and at least one adsorption component that are associated with one another. According to some embodiments, the composite filter aid may have properties significantly different from either the filtration component or adsorption component alone.

Without wishing to be bound by theory, it is believed that the above-noted combination of a composite filter aid having a pore volume of at east about 0.15 cm³/gram at an average pore size between 3 nanometers and 15 nanometers, may result in more effective chill-proofing of fluids, such as, for example, beer. It is believed that this combination may result in adsorbing an increased or maximized amount of chili haze active proteins (i.e., proteins believed to cause chill haze), while not significantly adsorbing other desirable proteins, such as, for example, foam active proteins.

According to some embodiments, it may be possible to obtain such a combination by controlling the at least partial coating of the precipitated silica on the filtration component. For example, for embodiments in which the silica is precipitated in situ onto the filtration component (e.g., diatomaceous earth), the reaction (during and/or after the reaction) may be controlled by controlling one or more of the reaction pH, percentage of solids of the reaction, and the percentage of silica precipitated onto the filtration component, to achieve the desired combination of pore volume and average pore size.

Precipitated silicas are a form of amorphous, non-crystalline silicon dioxide (SiO₂) that is typically porous. In some embodiments, the adsorption component may be a precipitated silica. In some embodiments, the adsorption component may be a silica gel. In some embodiments, the adsorption component may be a colloidal silica. In some embodiments, the adsorption component may be a fumed silica. In some embodiments, the adsorption component may be a silica fume. In some embodiments, the adsorption component can also be chosen from silicates. Non-limiting examples of suitable silicates include aluminosilicate, calcium silicate, and magnesium silicate. In still other embodiments, the adsorption component may include alumina. In some embodiments, the adsorption component may include an aluminosilicate. In some embodiments, the adsorption component may include a porous alumina.

According to some embodiments, the composite filter aid may have a pore volume of at least about 0.20 cm³/gram at an average pore size between 3 nanometers and 15 nanometers, as measured by nitrogen adsorption. For example, the composite filter aid may have a pore volume of at least about 0.25 cm³/gram at an average pore size ranging from 3 nanometers and 15 nanometers, or a pore volume of at least about 0.30 cm³/gram at an average pore size between 3 nanometers and 15 nanometers.

According to some embodiments, the composite filter aid may have a pore volume of ranging from at least about 0.15 cm³/gram to about 0.35 cm³/gram at an average pore size between 3 nanometers and 15 nanometers. For example, the composite filter aid may have a pore volume of ranging from at least about 0.20 cm³/gram to about 0.35 cm³/gram at an average pore size between 3 nanometers and 15 nanometers, a pore volume of ranging from at least about 0.25 cm³/gram to about 0.35 cm³/gram at an average pore size between 3 nanometers and 15 nanometers, or a pore volume of ranging from at least about 0.25 cm³/gram to about 0.30 cm³/gram at an average pore size between 3 nanometers and 15 nanometers.

According to some embodiments, the average pore size of the composite filter aid may be less than or equal to 15 nanometers. For example, the average pore size of the composite filter aid may be less than or equal to 12 nanometers, or less than or equal to 10 nanometers. According to some embodiments, the average pore size of the composite filter aid may be between 3 nanometers to 12 nanometers. For example, the average pore size of the composite filter aid may be between 3 nanometers to 10 nanometers. According to some embodiments, the average pore size of the composite filter aid may be between 5 nanometers to 15 nanometers. For example, the average pore size of the composite filter aid may be between 5 nanometers to 12 nanometers, or between 5 nanometers to 10 nanometers.

According to some embodiments, the composite filter aid may exhibit a chill haze reduction of at least 25%, For example, the composite filter aid may exhibit a chili haze reduction of at least 30%, at least 35%, or at least 40%. Chill haze reduction may be determined by the Chapon Test (ISO 5725 (1, 6)).

According to some embodiments, the adsorption component is precipitated in situ onto the filtration component. For example, the composite filter aid may be obtained by reacting a dispersion of water, the filtration component (e.g., diatomaceous earth), and sodium silicate with sulfuric acid to a pH of 8.5, and thereafter rinsing the material with water and drying. According to some embodiments, the reaction may be controlled to achieve a desired pore volume (e.g., an increased pore volume) in a desired pore size range. Such embodiments may result in a composite filter aid that has a desired pore volume in a pore size range that increases or maximizes chill haze reduction in fluids such as beer. For example, according to some embodiments, this may be achieved by controlling one or more of the reaction pH (during and/or after the reaction), the percentage of solids of the reaction, and the percentage of silica precipitated onto the filtration component (e.g., diatomaceous earth).

When performing nitrogen adsorption, specific surface area may be calculated using the BET (Brunauer-Emmett-Teller) theory, while pore size and pore volume may be calculated using the BJH (Barrett-Joyner-Halenda) theory.

The application of BET theory to a particular adsorbent component yields a measure of the material's specific surface area, known as “BET surface area.” BET surface area may be measured by any appropriate measurement technique known to those skilled in the art. In some embodiments, BET surface area is measured with a Gemini III 2375 Surface Area Analyzer, using nitrogen as the sorbent gas, from Micromeritics Instrument Corporation (Norcross, Ga., USA). As used herein, “surface area” refers to BET surface area, unless otherwise indicated.

According to some embodiments, the composite filter aid may have a BET surface area of at least 50 m²/gram. For example, the composite filter aid may have a BET surface area ranging from at least 50 m²/gram to 500 m²/gram, or ranging from at least 75 m²/gram to 250 m²/gram.

One technique for calculating pore size and pore volume is the Barrett-Joyner-Halenda (BJH) theory. The application of BJH theory to a particular adsorbent component yields a measure of the differential pore volume across a range of pore sizes. As used herein, pore volumes are calculated using the BJH theory unless otherwise indicated.

According to some embodiments, a large BET surface area of the adsorption component may permit the composite filter aid to reduce the number of particles and/or constituents that contribute to turbidity of the fluid. The composite filter aid may entrap particles and/or constituents from the unfiltered fluid, resulting in the filtered fluid having fewer particles and/or constituents. Further, the turbidity of a fluid filtered through the composite filter aids disclosed herein may be less than the turbidity of a fluid filtered through a simple mixture of an adsorption component and a filtration component, where the proportion of adsorption component to filtration component in the simple mixture is similar to, or even greater than, the proportion of adsorption component to filtration component of the composite filter aids disclosed herein. According to some embodiments, the turbidity of a fluid filtered through the composite filter aids disclosed herein may be less than the turbidity of a fluid filtered through a thermally-sintered or chemically-bonded composite of an adsorption component and a filtration component, where the proportion of adsorption component to filtration component in the thermally-sintered or chemically-bonded composite is similar to, or even greater than, the proportion of adsorption component to filtration component of the composite filter aids disclosed herein.

According to some embodiments, a method for removing particles from a fluid may include providing a chill-proofing composite filter aid. The composite filter aid may include a filtration component and an adsorption component including precipitated silica at least partially coating the filtration component. The composite filter aid may have a pore volume of at least about 0.15 cm³/gram at an average pore size between 3 nanometers and 15 nanometers. The method may further include pre-coating a filter element with the composite filter aid, and passing a fluid containing particles to be adsorbed through the coated filter element. According to some embodiments of the method, the fluid includes beer, and the method includes removing particles from beer. According to some embodiments of the method, the filtration component includes diatomaceous earth. According to some embodiments of this method, the composite filter aid incorporated into this method may have any of the characteristics of the composite filter aids described herein.

According to some embodiments, a method of making a chill-proofing composite filter aid may include providing a filtration component, and at least partially coating the filtration component with an adsorption component including precipitated silica. The composite filter aid may have a pore volume of at least about 0.15 cm³/gram at an average pore size between 3 nanometers and 15 nanometers. According to some embodiments, the filtration component includes diatomaceous earth. According to some embodiments of this method, the composite filter aid incorporated into this method may have any of the characteristics of the composite filter aids described herein.

According to some embodiments of the method, the adsorption component is precipitated in situ onto the surface of the filtration component. As a result of such embodiments, while simple mixtures may segregate upon suspension (e.g., in fluid, conveyance, or transport), the filter aid composition including at least one composite filter aid may retain both its component adsorptive and filtration properties. The in situ precipitation of the adsorption component on the at least one filtration component may also have superior absorptive and filtration properties than a thermally sintered or chemically bonded composite, for example, because the in situ precipitation process may produce a filter aid including at least one composite filter aid, wherein the adsorbent component is distributed substantially evenly on the filtration component and may present a relatively larger surface area for adsorption. The larger surface area may permit the filter aid to adsorb a greater fraction of chill haze forming proteins, which may result in a lower turbidity level for the filtered fluid after aging.

According to some embodiments of the method, the at least partially coating the filtration component with precipitated silica includes precipitating the precipitated silica in situ onto the filtration component. “Sodium silicate” refers herein to any one of several compounds including sodium oxide (Na₂O) and silica (SiO₂). Such combinations may include, for example, sodium ortho silicate (Na₄SiO₄), sodium meta silicate (Na₂SiO₃), and sodium disilicate (Na₂Si₂O₅). In some embodiments, the sodium silicate is a diatomite-based sodium silicate. In some embodiments, sodium silicate is substituted in whole or in part for at least one ammonium silicate and/or at least one alkali metal silicate, such as, for example, lithium, sodium, potassium, rubidium, and cesium silicates. Sodium silicate with a SiO₂/Na₂O ratio of about 3.2:1 and a concentration of 20% may be obtained, for example, from World Minerals, Inc. Sodium silicate with a SiO₂/Na₂O ratio of about 3:1 and a concentration of 34.6% may be obtained, for example, from PQ Corp.

Some embodiments of the method may include adding a sodium silicate solution to a filtration component suspension, raising the pH. The mass ratio of sodium silicate to the filtration component may be, for example, about 1:3, but other ratios are contemplated.

An acid, or a salt thereof, may then be added to the slurry in an amount sufficient to increase the acidity (i.e., reduce the pH) of the slurry to a pH range suitable for the precipitation of silica. Any suitable acid may be selected. In some embodiments, the acid may be sulfuric acid. In some embodiments, the acid may be phosphoric acid. In some embodiments, the acid may by hydrochloric acid, nitric acid, and/or acetic acid.

As the pH lowers, the slurry may be stirred periodically until gelling occurs. This may take about twenty-five to about sixty minutes, to a day or longer, depending on the acidity of the solution and the sodium silicate concentration in the slurry. The slurry may then be filtered. Water may be added to the suspension to aid filtration. The resulting cake may be washed with water. Then the cake may be dried until the excess fluid in the cake has evaporated. For example, the cake may be dried at a temperature ranging from about 110 degrees C. to about 350 degrees C., although the cake itself will remain at temperatures not much higher than 100 degrees C. during drying due to the presence of internal moisture.

The amount of the sodium silicate added may be chosen to control the pore size distribution in the composite filter aid. While increasing the percentage of precipitated silica generally acts to increase the filter aid material's ability to act as an adsorbent, it generally acts to decrease its ability to act as a filter material. Conversely, decreasing the percentage of precipitated silica generally acts to decrease the filter aid material's ability to act as an adsorbent while increasing its ability to act as a filter material.

According to some embodiments, the amount of the adsorption component in the composite filter aid may comprise from between about 5% to about 95% by weight of the total composite filter aid. In some embodiments, the adsorption component may comprise greater than about 10% by weight of the total composite filter aid. In some embodiments, the adsorption component may comprise greater than about 15% by weight of the total composite filter aid. In some embodiments, the adsorption component may comprise greater than about 25% by weight of the total composite filter aid. In some embodiments, the adsorption component may comprise less than about 40% by weight of the total composite filter aid. In some embodiments, the adsorption component may comprise less than about 50% by weight of the total composite filter aid. In some embodiments, the adsorption component may comprise from about 5% and about 40% by weight of the total composite filter aid. In some embodiments, the adsorption component may comprise from about 15% and 25% by weight of the total composite filter aid.

According to some embodiments, the amount of the filtration component in the composite filter aid may comprise from between about 5% to about 95% by weight of the total composite filter aid. In some embodiments, the filtration component may comprise greater than about 25% by weight of the total composite filter aid. In some embodiments, the filtration component may comprise greater than about 50% by weight of the total composite filter aid. In some embodiments, the filtration component may comprise greater than about 70% by weight of the total composite filter aid. In some embodiments, the filtration component may comprise less than about 80% by weight of the total composite filter aid. In some embodiments, the filtration component may comprise less than about 90% by weight of the total composite filter aid. In some embodiments, the filtration component may comprise from about 60% to about 95% by weight of the total composite filter aid. In some embodiments, the filtration component may comprise from about 75% to about 85% by weight of the total composite filter aid.

In some embodiments, the adsorption component may comprise from about 5% to about 40% by weight of the total composite filter aid, and the filtration component may comprise from about 60% to about 95% by weight of the total composite filter aid. In some embodiments, the adsorption component may comprise from about 15% to about 25% by weight of the total composite filter aid, and the filtration component may comprise from about 75% to about 85% by weight of the total composite filter aid. In some embodiments, the composite filter aid may comprise a greater amount by weight of the adsorption component than the filtration component.

After formation of the composite filter aid, according to some embodiments, the composite filter aid may then be mixed with at least one additional filtration component. The at least one additional filtration component may be chosen from any suitable filtration component previously known or hereinafter discovered, and may be either the same or different from the filtration component in the composite filter aid.

According to some embodiments, the method includes controlling at least one of pH, percentage of solids, and percentage of precipitated silica during precipitation of the precipitated silica onto the filtration component. According to some embodiments, the method includes controlling at least one of pH, percentage of solids, and percentage of precipitated silica after precipitation of the silica onto the filtration component. According to some embodiments, the method includes controlling at least one of pH, percentage of solids, and percentage of precipitated silica during and after precipitation of the silica onto the filtration component.

### EXAMPLES

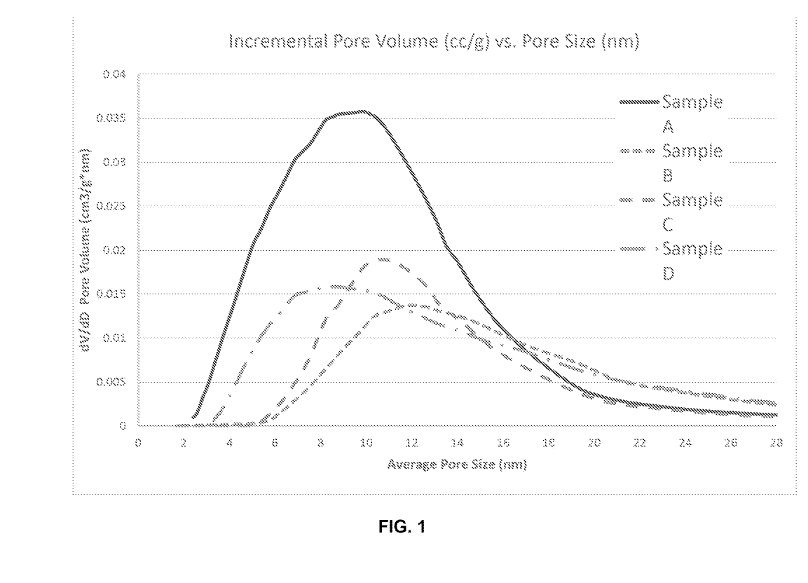

Four samples composite filter aids were prepared and tested to determine the pore volume as a function of average pore size. The four samples include a first sample (Sample A) consistent with exemplary embodiments disclosed herein, and three samples (Samples B-D) of conventional composite filter aids, FIG. 1 is a graph showing the incremental pore volume (cm³/gram) vs. average pore size (nanometers (nm)) for the four samples. As shown in FIG. 1, the Sample A has an increased pore volume compared to the tested conventional composite filter aids of Samples B-D. The pore volume in the 3 nanometer to 15 nanometer range of average pore size is believed more effective at adsorbing haze active proteins than in other average pore size ranges.

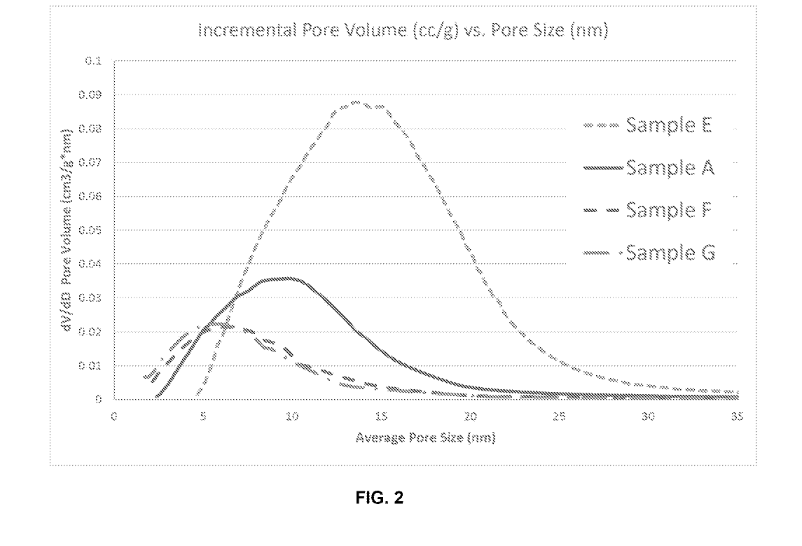

Sample A was also compared against a commercially available silica gel (Sample E) and two additional composite filter aid samples (Samples F and G). FIG. 2 is a graph showing the incremental pore volume (cm³/gram) vs. average pore size (nanometers (nm)) for Samples A and E-G. As shown in FIG. 2, the silica gel of Sample E has the highest pore volume, and its pore volume peaks at an average pore size of about 15 nanometers. This may be undesirable for at least two reasons. For example, the corresponding pore volume in the range desired for chill haze reduction is lower than for Sample E, and as silica gels age the pore sizes increase. As mentioned above, it is believed that an average pore size of about 15 nanometers is at the high end of the range of most effective average pore sizes for reducing chill haze, which is believed to be from 3 nanometers to 15 nanometers. Thus, Sample E may not be as effective at reducing chill haze as Sample 1, which has a pore volume that peaks about halfway between the desired average pore size range of 3 nanometers to 15 nanometers. Samples F and G have lower pore volumes than Sample 1, and the average pore volumes of Samples F and G peak at the low end of the range of average pore size desired for chill haze reduction. Thus, Sample A may be more effective at reducing chili haze than Samples E-G.

Table 1 below shows relevant data for a number of filter aid samples. The data includes data related to the reactions forming the filter aid samples, including percentage of solids, the reaction pH, the post reaction pH adjustment, the percentage of precipitated silica, and the reaction time. The data also includes the chill haze (EBC) of the fluids (i.e., beer) in which the samples were tested, the percentage chill haze reduction of the sample and beer, the measured pore volume of the sample, the measured pore volume of the sample measured between 3 nanometers and 15 nanometers, and the full range pore size in nanometers.

TABLE 1

| | | | Post- | | Reaction | Chill | Chill Haze | Pore Volume | Pore Volume | Fun range |
|---|---|---|---|---|---|---|---|---|---|---|
| Reaction | Reaction % | Reaction | Reaction pH | Precipitated | Time | Haze | Reduction | (cm3/g) | (cm3/g) | Pore Size |
| ID | Solids | pH | adjust | silica | (hours) | (EBC) | (%) | [1.7-300 nm] | [3-15 nm] | (nm) |
| Control | | | | | | 39.16 | | | | |
| Sample 1 | | 8.5 | 0 | 20 | 4 | 24.85 | 36.5 | 0.150 | 0.098 | 10.95 |
| Sample 2 | 15 | 8.5 | 0 | 20 | 24 | 26.18 | 33.1 | 0.170 | 0.116 | 10.86 |
| Sample 3 | 15 | 8.5 | 8.5 | 20 | 4 | 25.26 | 27.1 | 0.168 | 0.120 | 9.04 |
| Sample 4 | 15 | 8.5 | 8.5 | 20 | 24 | 25.85 | 25.4 | 0.180 | 0.132 | 8.23 |
| Sample 5 | 13.5 | 8.5 | 6 | 20 | 4 | 21.23 | 38.7 | 0.218 | 0.152 | 7.48 |
| Sample 6 | 15 | 8.5 | 6 | 20 | 4 | 23.42 | 40.2 | 0.234 | 0.148 | 6.48 |
| Sample 7 | 15 | 8.5 | 6 | 20 | 24 | 22.75 | 34.3 | 0.210 | 0.150 | 6.80 |
| Sample 8 | 17 | 8.5 | 6 | 20 | 4 | 21.00 | 39.4 | 0.206 | 0.146 | 6.39 |
| Sample 9 | 8 | 8.5 | 6 | 40 | 4 | 20.31 | 48.1 | 0.355 | 0.305 | 6.98 |
| Sample 10 | 10 | 8.5 | 6 | 40 | 4 | 20.73 | 47.1 | 0.358 | 0.313 | 7.41 |
| Sample 11 | 12 | 8.5 | 6 | 40 | 4 | 20.9 | 46.6 | 0.382 | 0.312 | 8.41 |
| Sample 12 | 13 | 8.5 | 6 | 40 | 4 | 20.54 | 47.5 | 0.402 | 0.314 | 9.51 |
| 100% Silica | | | | | | 19.63 | 49.9 | 1.130 | 0.410 | 15.8 |
| Gel | | | | | | | | | | |

As shown in Table 1, the Control is a calcined diatomaceous earth filter aid (Celite Standard Super Cel, available from Imerys Filtration Minerals, Inc.), which provides a comparison for Samples 1-12. Samples 1-12 include a filtration component (i.e., diatomaceous earth) having a silica precipitated in situ onto the filtration component according to different reaction parameters. Samples 1 and 2 were not subjected to post-reaction pH adjustment, but have different reaction times. Samples 3 and 4 were subjected to post-reaction pH adjustment to adjust the pH to 8.5 and according to different reaction times. Samples 5 and 6 have different reaction solids and underwent post-reaction pH adjustment to reduce the pH to 6. Samples 7 and 8 have different reaction solids and reaction times, with post-reaction pH adjustment down to 6. Samples 9 and 10 have different reaction solids with the same reaction times, with post-reaction pH adjustment down to 6 and a higher precipitated silica content (40%) relative to Samples 1-8 (20%). Samples 11 and 12 have different reaction solids with the same reaction times, with post-reaction pH adjustment down to 6 and a higher precipitated silica content (40%) relative to Samples 1-8 (20%).

As can be seen from the data of Table 1, the chill-haze reduction is highest in Samples 5-12, which have a pore volume of at least about 0.15 cm³/gram or greater at an average pore size between 3 nanometers and 15 nanometers. Samples 9-12, which include 40% precipitated silica, have the highest chill-haze reduction and have a pore volume of at least about 0.3 cm³/gram at an average pore size between 3 nanometers and 15 nanometers.

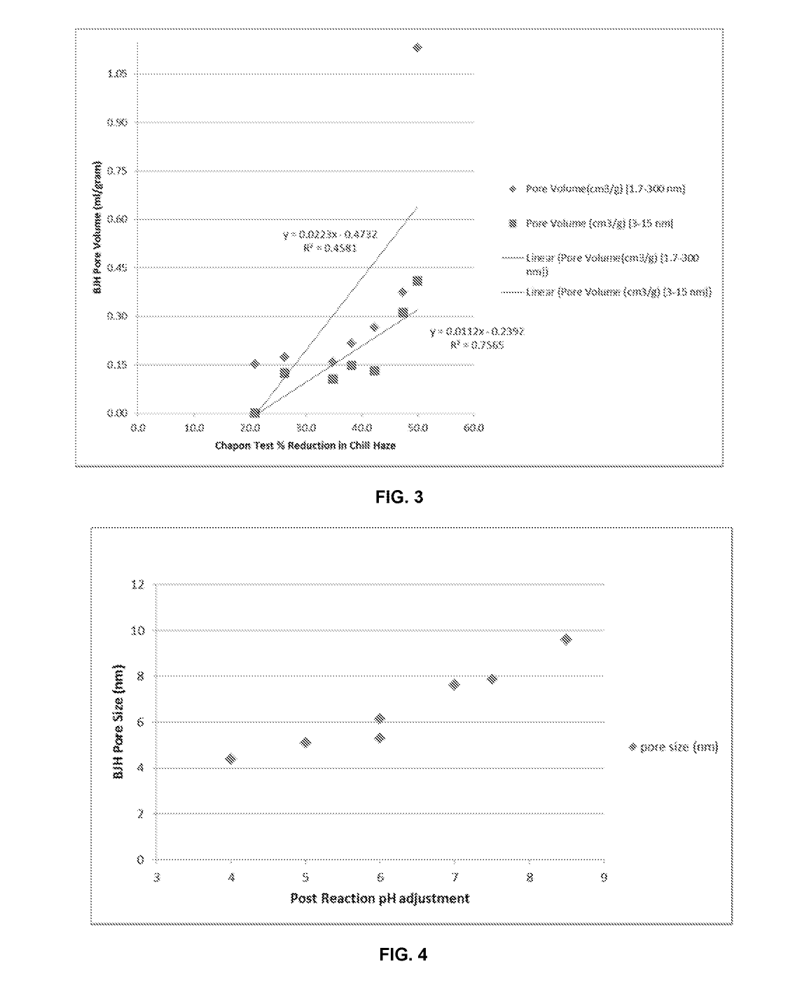

FIG. 3 is a graph showing the correlation between filter aid pore volume and chill haze reduction tested for high gravity BUDWEISER® beer. As shown in FIG. 3, as pore volume increases, chill haze reduction increases.

FIG. 4 is a graph showing the effect of post-reaction pH adjustment on the pore size of precipitated silica samples. As shown in FIG. 4, adjusting the pH of the composite filter aid post reaction affects the pore size. Reducing the pH reduces the pore size.

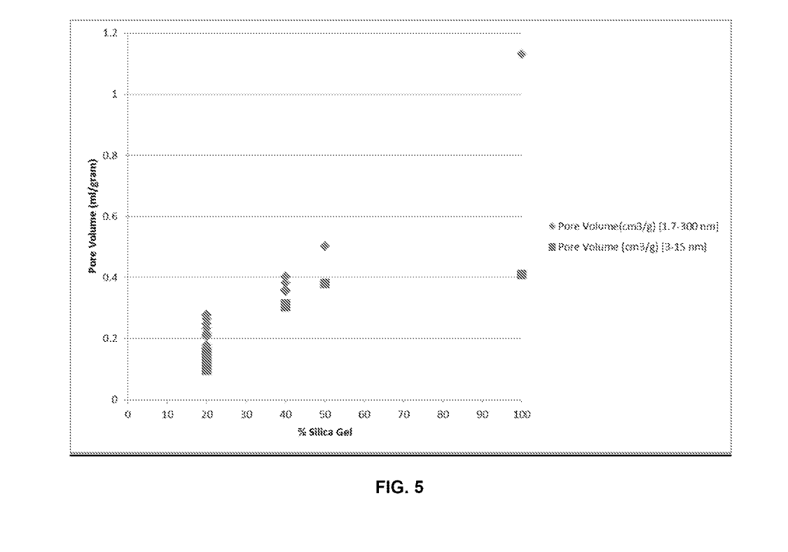

FIG. 5 is a graph showing the pore volume of two filter aid samples as a function of precipitated silica loading on diatomaceous earth. As shown in FIG. 5, adjusting the precipitated silica loading affects the pore volume, with the increased loading correlating with increased pore volume.

Other embodiments will be apparent to those skilled in the art from consideration of the specification and practice of the embodiments disclosed herein, it is intended that the specification and examples be considered as exemplary only.

1. A chill-proofing composite filter aid comprising:
a filtration component; and
an adsorption component comprising precipitated silica at least partially coating the filtration component,
wherein the composite filter aid has a pore volume of at least about 0.15 cm³/gram at an average pore size between 3 nanometers and 15 nanometers.

2. The composite filter aid of claim 1, wherein the filtration component comprises diatomaceous earth.

3. The composite filter aid of claim 1, wherein the composite filter aid has a pore volume of at least about 0.20 cm³/gram at an average pore size between 3 nanometers and 15 nanometers.

4. (canceled)

5. (canceled)

6. The composite filter aid of claim 1, wherein the composite filter aid has a pore volume of ranging from at least about 0.15 cm³/gram to about 0.35 cm³/gram at an average pore size between 3 nanometers and 15 nanometers.

7. The composite filter aid of claim 1, wherein the composite filter aid has a pore volume of ranging from at least about 0.20 cm³/gram to about 0.35 cm³/gram at an average pore size between 3 nanometers and 15 nanometers.

8. The composite filter aid of claim 1, wherein the composite filter aid has a pore volume of ranging from at least about 0.25 cm³/gram to about 0.35 cm³/gram at an average pore size between 3 nanometers and 15 nanometers.

9. (canceled)

10. The composite filter aid of claim 1, wherein the average pore size of the composite filter aid is less than or equal to 15 nanometers.

11. (canceled)

12. (canceled)

13. The composite filter aid of claim 1, wherein the average pore size of the composite filter aid is between 3 nanometers to 12 nanometers.

14. (canceled)

15. The composite filter aid of claim 1, wherein the average pore size of the composite filter aid is between 5 nanometers to 15 nanometers.

16. (canceled)

17. (canceled)

18. The composite filter aid of claim 1, wherein the composite filter aid exhibits a chill haze reduction of at least 25%.

19-21. (canceled)

22. The composite filter aid of claim 1, wherein the adsorption component is precipitated in situ onto the filtration component.

23. The composite filter aid of claim 1, wherein the composite filter aid has a BET surface area of at least 50 m²/gram.

24. The composite filter aid of claim 1, wherein the composite filter aid has a BET surface area ranging from at least 50 m²/gram to 500 m²/gram.

25. (canceled)

26. The composite filter aid of claim 1, wherein the precipitated silica comprises silica gel.

27. A method for removing particles from a fluid, the method comprising:
providing a chill-proofing composite filter aid comprising
a filtration component, and
an adsorption component comprising precipitated silica at least partially coating the filtration component,
wherein the composite filter aid has a pore volume of at least about 0.15 cm³/gram at an average pore size between 3 nanometers and 15 nanometers;
pre-coating a filter element with the composite filter aid; and
passing a fluid containing particles to be adsorbed through the coated filter element.

28. The method of claim 27, wherein the fluid includes beer.

29. The method of claim 27, wherein the filtration component comprises diatomaceous earth.

30. A method of making a chill-proofing composite filter aid, the method comprising:
providing a filtration component;
at least partially coating the filtration component with an adsorption component comprising precipitated silica,
wherein the composite filter aid has a pore volume of at least about 0.15 cm³/gram at an average pore size between 3 nanometers and 15 nanometers.

31. The method of claim 30, wherein the at least partially coating the filtration component with precipitated silica comprises precipitating the silica in situ onto the filtration component.

32. The method of claim 30, wherein the filtration component comprises diatomaceous earth.
